(19) United States
(12) Patent Application Publication
(10) Pub. No.: US 2005/0236994 A1
(43) Pub. Date: Oct. 27, 2005

(54) Plasma display panel

(76) Inventors: Jae-Ik Kwon, Suwon-si (KR); Kyoung-Doo Kang, Suwon-si (KR)

Correspondence Address: CHRISTIE, PARKER & HALE, LLP, PO BOX 7068, PASADENA, CA, 91109-7068, US

(21) Appl. No.: 11/110,110

(22) Filed: Apr. 19, 2005

(30) Foreign Application Priority Data
Apr. 21, 2004 (KR) 10-2004-0027413
Nov. 30, 2004 (KR) 10-2004-0099526

(51) Int. Cl. H01J 17/49

(52) U.S. Cl. 313/584; 313/582

(57) ABSTRACT

A plasma display panel capable of reducing or preventing panel breakage and aging failure during the aging process for discharge stabilization. The plasma display panel includes first and second substrates facing each other and having a display region at a center of the substrates, a non-display region formed around a periphery of the display region, and an intermediate region disposed between the display region and the non-display region. Address electrodes are formed on the first substrate and extend parallel to each other. Barrier ribs are arranged at the display region and the intermediate region. The barrier ribs define discharge cells between the substrates. Display electrodes are formed on the second substrate in a direction crossing the address electrodes. An area ratio of the display electrodes to corresponding discharge cells in the intermediate region is smaller than the area ratio thereof in the display region.

### CROSS REFERENCE TO RELATED APPLICATION

This application claims priority to and the benefit of Korean Patent Application Nos. 10-2004-0027413 and 10-2004-0099526 filed on Apr. 21, 2004 and Nov. 30, 2004, respectively, in the Korean Intellectual Property Office, the entire disclosures of which are incorporated herein by reference.

### BACKGROUND OF THE INVENTION

1. Field of the Invention

The present invention relates to a plasma display panel, and in particular, to a plasma display panel which prevents the panel breakage and the aging failure in conducting the aging process for discharge stabilization.

2. Description of Related Art

Generally, a plasma display panel (referred to hereinafter simply as the “PDP”) is a display device which displays images by exciting phosphors with ultraviolet rays generated due to the gas discharge within the discharge cells. As the PDP enables the construction of a high resolution, wide-screened display device, it is in the spotlight as a slim display device of the future.

The PDPs commonly have a triode surface discharge structure. The triode surface discharge PDP includes a first substrate with address electrodes, and a second substrate spaced apart from the first substrate with two electrodes placed at the same plane. Barrier ribs are disposed between the two substrates to partition a plurality of discharge cells.

A display region where the discharge cells are used for displaying images, and a non-display region with a dummy region and a terminal region that are not used for displaying purposes, are demarcated at the two substrates.

The process of manufacturing the plasma display panel first includes the steps of forming address electrodes, a lower dielectric layer, barrier ribs and phosphor layers on the first substrate. Second, display electrodes, an upper dielectric layer and an MgO protective layer are formed on the second substrate. Third, the first and second substrates are assembled with each other. Fourth, the inner space between the two substrates is exhausted, and a discharge gas is injected into the space. Fifth, the discharge space is aged to realize a discharge stabilization. Sixth, the PDP is assembled together with a chassis base, a driving circuit board, and an outer case.

Among the processes, the aging process is used to stabilize the electrical and optical characteristics of the PDP by discharging the inner space of the discharge cells for a predetermined period of time. With the aging, the MgO protective layer is activated while stabilizing the discharge gas, and the impurities in the phosphor layers are removed. In particular, when the surface of the MgO protective layer is activated through aging, the discharge is made in a stable manner, and the phosphor layers emit light with sufficient brightness. Accordingly, the PDP being subjected to sufficient aging involves higher discharge voltage and screen brightness.

The practical aging process is conducted by alternately applying waveforms of 20-50 kHz, 200-350V to the scanning electrode and the common electrode belonging to the display electrodes, and the duty ratio is typically established to be 40-70%.

However, during the aging process, a temperature difference is made between the display region where the displaying is performed with discharge cells and the non-display region surrounding the display region, such that the PDP may be broken because of the temperature difference.

For instance, when a waveform of 30 kHz, 300V with a duty ratio of 60% is applied to the display electrodes during the aging process, the temperature at the non-display region turns out to be about 30° C., whereas the temperature at the display region turns out to be about 90° C. Accordingly, the temperature difference between the display region and the non-display region reaches 60° C., and this can directly cause the panel breakage.

### SUMMARY OF THE INVENTION

It is an aspect of the present invention to provide a PDP which minimizes or reduces the panel breakage and the aging failure by lowering a temperature difference and/or a steep temperature gradient between the display region and the non-display region during the aging process.

This and other aspects of the present invention may be achieved by a PDP with the following features.

In an exemplary embodiment according to the present invention, a PDP includes first and second substrates facing each other and having a display region at a center of the substrates, a non-display region formed around a periphery of the display region, and an intermediate region disposed between the display region and the non-display region. Address electrodes are formed on the first substrate and extend parallel to each other. Barrier ribs are arranged at the display region and the intermediate region, and define discharge cells between the first and second substrates. Phosphor layers are formed within the discharge cells in the display region. Display electrodes are formed on the second substrate in a direction crossing the address electrodes. An area ratio of the display electrodes to corresponding discharge cells in the intermediate region is smaller than an area ratio of the display electrodes to corresponding discharge cells in the display region.

According to one aspect of the present invention, an area of the display electrodes corresponding to respective discharge cells in the intermediate region is smaller than an area of the display electrodes corresponding to respective discharge cells in the display region.

The display electrodes may include a pair of bus electrodes formed near an outer periphery of the respective discharge cells, and a pair of protrusion electrodes extending from the bus electrodes toward a center of the respective discharge cells and facing each other. An area of the protrusion electrodes corresponding to the respective discharge cells in the intermediate region may be smaller than an area of the protrusion electrodes corresponding to the respective discharge cells in the display region.

A width measured in a longitudinal direction of the bus electrodes of the protrusion electrodes corresponding to the respective discharge cells in the intermediate region may be smaller than a width measured in the longitudinal direction of the bus electrodes of the protrusion electrodes corresponding to the respective discharge cells in the display region.

According to another aspect of the present invention, an area ratio of the display electrodes to the corresponding discharge cells in the intermediate region close to the non-display region is smaller than the area ratio of the display electrodes to the corresponding discharge cells in the intermediate region close to the display region.

The display electrodes may include bus electrodes longitudinally extending near a periphery of respective discharge cells in a direction crossing the address electrodes, and protrusion electrodes extending from the bus electrodes toward a center of the respective discharge cells. An area of the protrusion electrodes in the intermediate region close to the non-display region may be smaller than an area of the protrusion electrodes in the intermediate region close to the display region.

The area of the protrusion electrodes in the intermediate region may be gradually reduced from a first area of the protrusion electrodes close to the display region to a second area of the protrusion electrodes close to the non-display region.

A width of the protrusion electrodes measured at the intermediate region in a direction parallel to the bus electrodes may be gradually reduced from a first width of the protrusion electrodes placed close to the display region to a second width of the protrusion electrodes placed close to the non-display region.

The discharge cells in the intermediate region may have substantially the same area as each other.

An area of the discharge cells in the intermediate region may be larger than an area of the discharge cells in the display region. The area of the discharge cells in the intermediate region close to the non-display region may be larger than the area of the discharge cells in the intermediate region close to the display region.

The area of the discharge cells in the intermediate region may be gradually enlarged from a first area of the discharge cells close to the display region to a second area of the discharge cells close to the non-display region.

The intermediate region may include a first intermediate sub-region adjacent to the display region in a direction of the display electrodes, and a second intermediate sub-region adjacent to the display region in a direction crossing the display electrodes.

A width of the discharge cells in the first intermediate sub-region measured in the direction of the display electrodes may be gradually enlarged from a first width of the discharge cells close to the display region to a second width of the discharge cells close to the non-display region. A length of the discharge cells in the second intermediate sub-region measured in the direction crossing the display electrodes may be gradually enlarged from a first length of the discharge cells close to the display region to a second length of the discharge cells close to the non-display region.

The display electrodes corresponding to the respective discharge cells in the intermediate region may have substantially the same area as each other.

The address electrodes may be formed in the display region, or in both the display region and the intermediate region.

According to still another aspect of the present invention, rear ends of the protrusion electrodes connected to the bus electrodes are gradually reduced in width toward the bus electrodes, and a groove may be formed at a center of front end edges of the pair of protrusion electrodes that face each other.

In this case, the rear ends of the protrusion electrodes corresponding to the respective discharge cells in the intermediate region and connected to the bus electrodes may be smaller in width than the rear ends of the protrusion electrodes corresponding to the respective discharge cells in the display region. The width of the front end edges of the pair of protrusion electrodes corresponding to the respective discharge cells in the intermediate region may be smaller than the width of the front end edges of the pair of protrusion electrodes corresponding to the respective discharge cells in the display region.

As stated above, in the PDP according to exemplary embodiments of the present invention, an intermediate region is disposed between the display region and the non-display region to thereby compensate for the significant temperature difference between the display region and the non-display region during the aging process. Accordingly, the panel breakage and the aging failure are reduced or prevented during the aging process, and sufficient aging is conducted to thereby stabilize the electrical and optical characteristics of the PDP.

Further, address electrodes may be formed in the intermediate region as well as in the display region to thereby prevent the possible mis-discharging in the intermediate region.

### BRIEF DESCRIPTION OF THE DRAWINGS

The above and other features of the present invention will become more apparent by describing certain exemplary embodiments thereof in detail with reference to the accompanying drawings in which:

FIG. 1 is a schematic plan view of a PDP that can be used to implement exemplary embodiments of the present invention;

FIG. 2 is a partial exploded perspective view of a PDP according to a first exemplary embodiment of the present invention, illustrating discharge cells in a display region;

FIG. 3 is a partial plan view of the PDP according to the first exemplary embodiment of the present invention, illustrating the discharge cells at the display region and an intermediate region;

FIG. 4 is a partial plan view of a PDP according to a second exemplary embodiment of the present invention, illustrating discharge cells at a display region and an intermediate region;

FIG. 5 is a partial plan view of a PDP according to a third exemplary embodiment of the present invention, illustrating discharge cells at a display region and an intermediate region;

FIG. 6 is a partial plan view of a PDP according to a fourth exemplary embodiment of the present invention, illustrating discharge cells at a display region and an intermediate region;

FIG. 7 is a partial exploded perspective view of a PDP according to a fifth exemplary embodiment of the present invention, illustrating discharge cells at a display region; and

FIG. 8 is a partial plan view of the PDP according to the fifth exemplary embodiment of the present invention, illustrating the discharge cells at the display region and an intermediate region.

### DETAILED DESCRIPTION

The present invention will be described more fully hereinafter with reference to the accompanying drawings, in which certain exemplary embodiments of the present invention are shown.

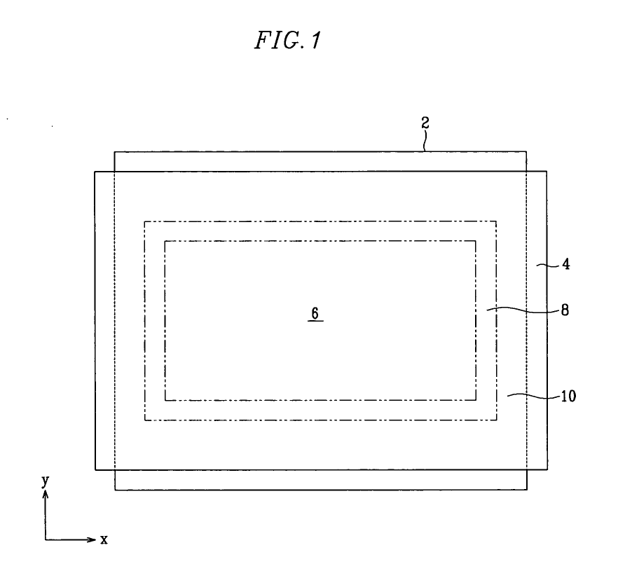

FIG. 1 is a schematic plan view of a PDP that can be used to implement exemplary embodiments of the present invention. First through fifth exemplary embodiments will be described herein with reference to FIG. 1, and those skilled in the art would understand that any one of the first through fifth exemplary embodiments can be implemented in the PDP of FIG. 1, without being limited thereto.

As shown in FIG. 1, a first substrate 2 (referred to hereinafter as the “rear substrate”) and a second substrate 4 (referred to hereinafter as the “front substrate”) are arranged substantially parallel to each other with a predetermined distance or gap therebetween, and assembled with each other to outline the PDP. A display region 6, an intermediate region 8 and a non-display region 10 are demarcated (e.g., shown in phantom lines) at the rear and front substrates 2 and 4.

The substantial displaying is made at the display region 6, and the space between the rear and front substrates 2 and 4 are partitioned into a plurality of discharge cells using barrier ribs. Phosphor layers are formed within the discharge cells, and a discharge gas is injected into the cells.

The intermediate region 8 externally surrounds the display region 6 with discharge cells similar to the discharge cells of the display region 6, but is not used for displaying purposes. The discharge cells placed at the intermediate region 8 are used to perform the aging process, and during the aging process, compensate for the temperature difference between the display region 6 and the non-display region 10.

The non-display region 10 externally surrounds the intermediate region 8, and is not used for displaying purposes. The non-display region 10 includes a dummy region with dummy cells, and a terminal region interconnecting the electrodes internal to the PDP and the terminals external thereto.

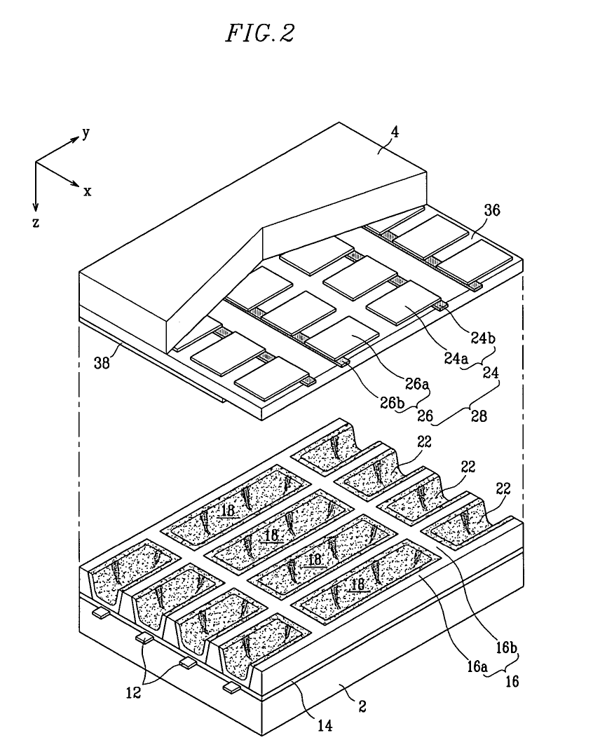

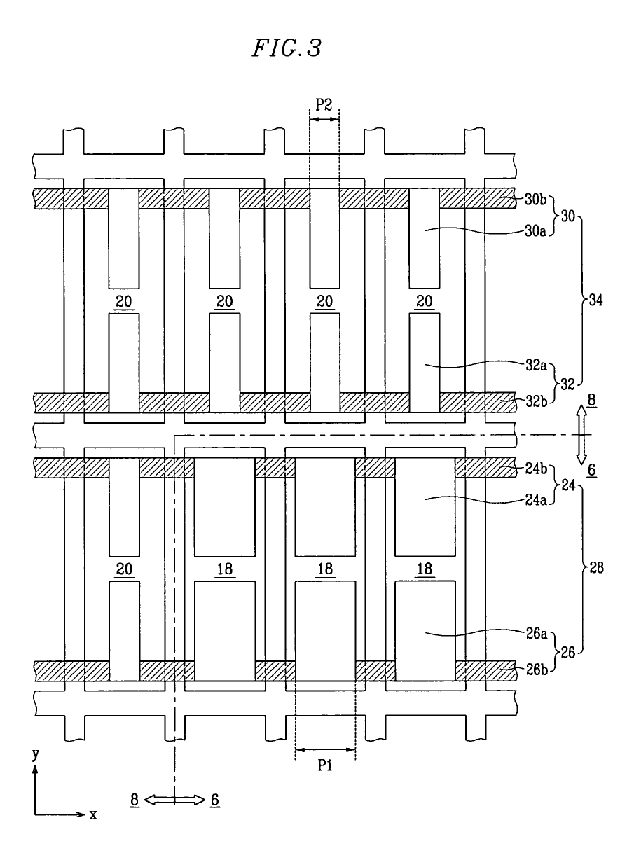

FIG. 2 is a partial exploded perspective view of a PDP according to a first exemplary embodiment of the present invention, illustrating the discharge cells at a display region, and FIG. 3 is a partial plan view of the PDP according to the first exemplary embodiment of the present invention, illustrating the discharge cells at the display region and an intermediate region.

As shown in FIGS. 2 and 3, address electrodes 12 are formed on the surface of the rear substrate 2 facing the front substrate 4 and extending in a first direction (i.e., in the y axis direction of FIGS. 2 and 3). A dielectric layer 14 is formed on the front surface of the rear substrate 2, and covers the address electrodes 12. The address electrodes 12 are spaced apart from each other with a predetermined distance therebetween, while extending in parallel.

Barrier ribs 16 are formed on the dielectric layer 14 to partition a plurality of discharge cells 18 and 20. For instance, the barrier ribs 16 are formed with first barrier rib portions 16a that extend in a direction parallel to the address electrodes 12 (i.e., in the y axis direction of FIGS. 2 and 3), and second barrier rib portions 16b that cross and extend in a direction substantially perpendicular to the first barrier rib portions 16a (i.e., in the x axis direction of FIGS. 2 and 3). The barrier ribs are not limited to the above structure, but may be altered in various different manners, such as a stripe structure formed only with barrier rib portions that extend in a direction parallel to the address electrodes. Barrier ribs having such a stripe structure, as well as any other suitable barrier rib structures, also are within the scope of the present invention.

Red, green and blue phosphor layers 22 are necessarily provided within the discharge cells 18 at the display region 6, whereas they are selectively provided within the discharge cells 20 at the intermediate region 8.

Display electrodes 28 and 34 are formed on the surface of the front substrate 4 facing the rear substrate 2 and extending in a direction crossing the address electrodes 12 (i.e., in the x axis direction of FIGS. 2 and 3). The display electrodes 28 and 34 include display electrodes 28 corresponding to the discharge cells 18 in the display region 6, and display electrodes 34 corresponding to the discharge cells 20 in the intermediate region 8. The display electrodes 28 and 34 are formed with scan electrodes 24 and 30 and sustain electrodes 26 and 32. The scan electrodes 24 and 30 and the sustain electrodes 26 and 32 are respectively provided with bus electrodes 24b, 30b, 26b and 32b that longitudinally extend in the direction crossing the address electrodes 12 (i.e., in the x axis direction of FIGS. 2 and 3), and protrusion electrodes (“extension electrodes”) 24a, 30a, 26a and 32a that respectively extend from the bus electrodes 24b, 30b, 26b and 32b toward the center of the discharge cells 18 and 20.

The protrusion electrodes 24a, 26a, 30a and 32a have a role of making the plasma discharge within the discharge cells 18 and 20, and are formed with a transparent material, such as indium tin oxide (ITO), to obtain a desired aperture ratio. The bus electrodes 24b, 26b, 30b and 32b are used to compensate for the high resistance of the protrusion electrodes 24a, 26a, 30a and 32a and make a desired electrical communication, and may be formed with an opaque metallic material.

A dielectric layer 36 and an MgO protective layer 38 are sequentially formed on the front surface of the front substrate 4 while covering the display electrodes 28 and 34. The MgO protective layer 38 prevents the dielectric layer 36 from being struck by the ions released during the plasma discharge, and enhances the discharge efficiency with a high secondary electron discharge coefficient.

The area ratio of the display electrodes 28 to the corresponding discharge cells 18 in the display region 6 is established to be smaller than the area ratio of the display electrodes 34 to the corresponding discharge cells 20 at the intermediate region 8. The area of the discharge cells 18 and 20 and the display electrodes 28 and 34 is measured from the front side of the panel.

As shown in FIG. 3, the area of the display electrodes 34 placed within the respective discharge cells 20 at the intermediate region 8 is established to be smaller than that of the display electrodes 28 placed within the respective discharge cells 18 at the display region 6. The area of the protrusion electrodes 30a and 32a placed within the respective discharge cells 20 at the intermediate region 8 should be established to be smaller than that of the protrusion electrodes 24a and 26a placed within the respective discharge cells 18 at the display region 6. In this case, the gaps between the protrusion electrodes 24a and 26a, and between the protrusion electrodes 30a and 32a are the same for all the discharge cells 20 in the intermediate region 8 as well as for all the discharge cells 18 in the display region 6.

When the width of the protrusion electrodes 24a and 26a measured in the longitudinal direction of the bus electrodes 24b and 26b (i.e., in the x axis direction of FIG. 3) within the respective discharge cells 18 at the display region 6 is indicated by p1, and that of the protrusion electrodes 30a and 32a measured in the longitudinal direction of the bus electrodes 30b and 32b within the respective discharge cells 20 at the intermediate region 8 is indicated by p2, the protrusion electrodes 24a, 26a, 30a and 32a satisfy the condition of p1>p2.

With the above structure, when waveforms of 20-50 kHz, 200-350V with a duty ratio of 40-70% are alternately applied to the scanning electrodes 24 and 30 and the sustain electrodes 26 and 32 to conduct the aging process, the gaps between the protrusion electrodes 24a, 26a, 30a and 32a at the display region 6 as well as at the intermediate region 8 have the same dimension while not making any significant difference in the discharge initiation voltage. Consequently, the discharge is initiated in a stable manner, and the discharge current flows in proportion to the area of the protrusion electrodes 24a, 26a, 30a and 32a so that the discharge current at the intermediate region 8 is smaller than that at the display region 6.

Accordingly, when the temperature at the display region 6 during the aging process is T1, the temperature at the intermediate region 8 is T2 and the temperature at the non-display region 10 is T3, the condition of T1>T2>T3 is satisfied. Hence, when compared to the conventional PDP with no intermediate region 8, the temperature difference between the display region 6 and the non-display region 10 is reduced and/or the transition of temperature between the display region 6 and the intermediate region 8 is more gradual. Consequently, with the PDP according to the exemplary embodiment of the present invention, the significant temperature difference between the display region 6 and the non-display region 10 can be reduced and/or be made more gradual, and hence, the panel breakage and the aging failure can be reduced or prevented.

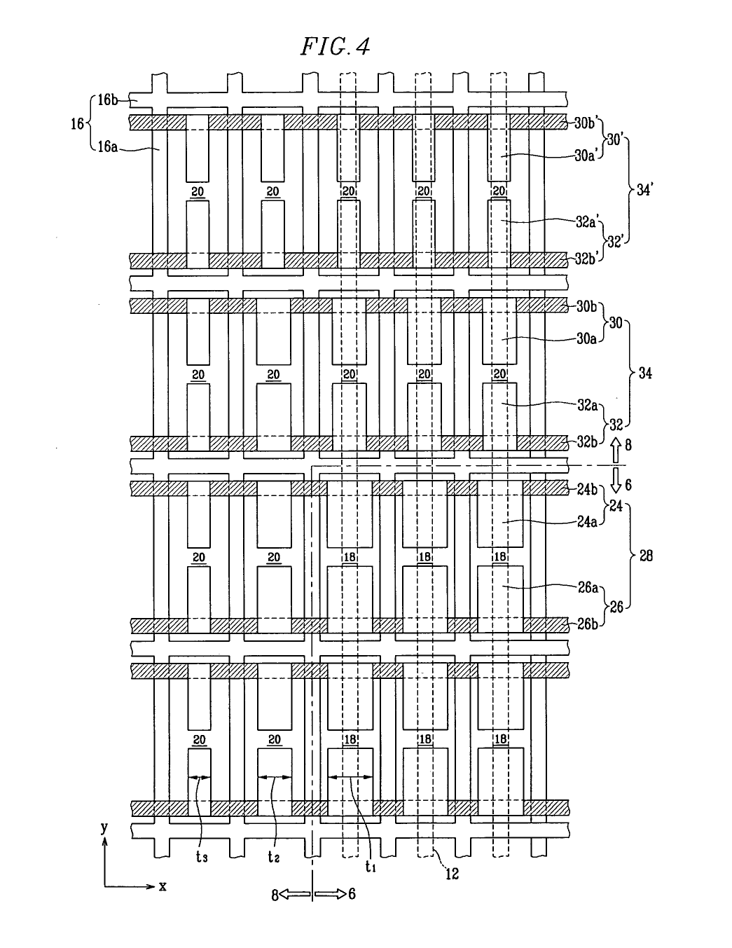

FIG. 4 is a partial plan view of a PDP according to a second exemplary embodiment of the present invention, illustrating discharge cells in a display region and an intermediate region.

As shown in FIG. 4, the area ratio of the display electrodes 34 and 34′ to the corresponding discharge cells 20 in the intermediate region is established to be smaller than the area ratio of the display electrodes 28 to the corresponding discharge cells 18 in the display region 6. Further, within the intermediate region 8, the area of the display electrodes 34′ placed close to the non-display region 10 is established to be smaller than that of the display electrodes 34 placed close to the display region 6.

For this purpose, the discharge cells 20 placed in the intermediate region are formed evenly in area, and the areas of the protrusion electrodes (“extension electrodes”) 24a and 26a, 30a and 32a, and 30a′ and 32a′ are differentiated between the display region 6 and the intermediate region 8 as well as within the intermediate region.

In this embodiment, in order to make the areas of the protrusion electrodes 24a, 26a, 30a, 32a, 30a′ and 32a′ different from each other, the widths of the protrusion electrodes 24a, 26a, 30a, 32a, 30a′ and 32a′ may be made different from each other. The widths of the protrusion electrodes 24a, 26a, 30a, 32a, 30a′ and 32a′ are measured in a direction extending parallel to the bus electrodes 24b, 26b, 30b, 32b, 30b′ and 32b′ (i.e., in the x axis direction of FIG. 4). In addition to or alternatively to making the widths of the protrusion electrodes 24a, 26a, 30a, 32a, 30a′ and 32a′ different from each other, various techniques may be applied to make the areas of the protrusion electrodes 24a, 26a, 30a, 32a, 30a′ and 32a′ different from each other, which are also within the scope of the present invention.

In the second exemplary embodiment, the protrusion electrodes 24a, 26a, 30a, 32a, 30a′ and 32a′ corresponding to the corresponding discharge cells 18 and 20 satisfy the condition of t1>t2>t3 where t1 indicates the width of the protrusion electrode 24a and 26a corresponding to the discharge cells 18 in the display region 6, t2 indicates the width of the protrusion electrodes 30a and 32a corresponding to the discharge cells 20 in the intermediate region 8 close to the display region 6, and t3 indicates the width of the protrusion electrodes 30a′ and 32a′ corresponding to the discharge cells 20 in the intermediate region 8 close to the non-display region 10.

For explanatory convenience, the discharge cells in the intermediate region are partially illustrated in the drawings and the specification, but further discharge cells may be formed in the intermediate region. In such cases, the width of the protrusion electrodes corresponding to the discharge cells may be gradually reduced from a location on the intermediate region close to the display region toward another location on the intermediate region close to the non-display region.

Accordingly, the area of the protrusion electrodes is gradually reduced from the protrusion electrodes 24a and 26a in the display region 6 to the protrusion electrodes 30a′ and 32a′ in the intermediate region 8 close to the non-display region 10. As the discharge current flows proportionally to the area of the protrusion electrodes 24a, 26a, 30a, 32a, 30a′ and 32a′, the electrical current that flows at the protrusion electrodes 24a, 26a, 30a, 32a, 30a′ and 32a′ is gradually reduced from the display region 6 to a location on the intermediate region 8 close to the non-display region 10.

Accordingly, in the intermediate region 8 during the aging process, the temperature is gradually reduced from the location close to the display region 6 to the location close to the non-display region 10. Consequently, any significant temperature difference and/or a steep temperature gradient is not made between the display region 6 and the non-display region 10, and the aging failure and the panel breakage can be effectively prevented.

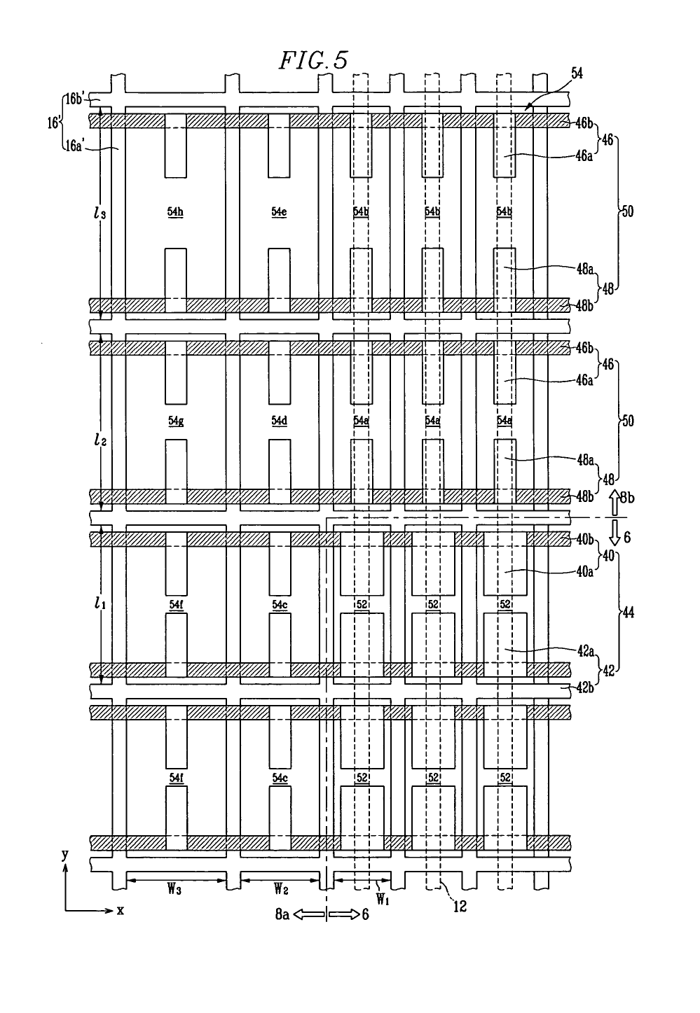

FIG. 5 is a partial plan view of a PDP according to a third exemplary embodiment of the present invention, illustrating a display region and an intermediate region thereof. Unlike the barrier ribs 16 (16a, 16b) if FIGS. 2 to 4. Barrier ribs 16′ (16a′, 16b′) as shown in FIG. 5 are not spaced apart from each other at equal intervals, but at different intervals between the display region and the intermediate region, and also between different locations within the intermediate region.

In this embodiment, the display electrodes 44 and 50 include display electrodes 44 corresponding to discharge cells 52 in the display region 6, and display electrodes 50 corresponding to discharge cells 54 (i.e., discharge cells 54a, 54b, 54c, 54d, 54e, 54f, 54g, 54h) in the intermediate region 8. The display electrodes 44 and 50 respectively include scan electrodes 40 and 46, and sustain electrodes 42 and 48. The scan electrodes 40 and 46 and the sustain electrodes 42 and 48 respectively include bus electrodes 40b, 46b, 42b and 48b that are longitudinally formed in a direction crossing the address electrodes 12, and protrusion electrodes (“extension electrodes”) 40a, 46a, 42a and 48a that extend from the bus electrodes 40b, 46b, 42b and 48b toward the center of the discharge cells 52 and 54, respectively.

The protrusion electrodes 40a, 42a, 46a and 48a have a role of making the plasma discharge within the discharge cells 52 and 54, and are formed with a transparent material, such as indium tin oxide (ITO), to obtain a desired aperture ratio. The bus electrodes 40b, 42b, 46b and 48b compensate for the high resistance of the protrusion electrodes 40a, 42a, 46a and 48a to thereby make a desired electrical communication, and are formed with an opaque metallic material.

In this embodiment, the display electrodes 50 corresponding to the respective discharge cells 54 in the intermediate region 8 have the same area, and the discharge cells 54 in the intermediate region 8 have an area larger than the discharge cells 52 in the display region 6. The discharge cells 54 have different areas even within the intermediate region 8 such that the portion thereof (e.g., the discharge cells 54f, 54g, 54h) placed close to the non-display region 10 has an area larger than the portion thereof (e.g., the discharged cells 54a, 54b, 54c, 54d, 54e) placed close to the display region 6.

For this purpose, the discharge cells 52 and 54 have width and/or length that are different from each other. The width of the discharge cells 52 and 54 is measured in the longitudinal direction of the display electrodes 44 and 50 (i.e., in the x axis direction of FIG. 5). The length of the discharge cells 52 and 54 is measured in the direction crossing the display electrodes 44 and 50 (i.e., in the y axis direction of FIG. 5).

In this embodiment, the intermediate region 8 includes a first intermediate sub-region 8a which is adjacent to the display region 6 in the direction parallel to the display electrodes (i.e., in the x axis direction of FIG. 5), and a second intermediate sub-region 8b which is adjacent to the display region 6 in the direction crossing the display electrodes.

The display region 6 and the first intermediate sub-region 8a are established to satisfy the condition of w3>w2>w1 where w1 is the width of the discharge cells 52 in the display region 6, w2 is the width of the discharge cells 54c, 54d, 54e in the first intermediate sub-region 8a close to the display region 6, and w3 is the width of the discharge cells 54f, 54g, 54h in the second intermediate sub-region 8a close to the non-display region 10.

Further, in this embodiment, the discharge cells are established to satisfy the condition of l3>l2>l1 where l1 is the length of the discharge cells 52 in the display region 6, l2 is the length of the discharge cells 54a in the second intermediate sub-region 8b close to the display region 6, and l3 is the length of the discharge cells 54b in the second intermediate sub-region 8b close to the non-display region 10.

For explanatory convenience, the discharge cells in the intermediate region are partially illustrated in the drawings and the specification, but further discharge cells may be formed at the intermediate region. Even in such cases, the area of the discharge cells 54 in the intermediate region 8 may be gradually enlarged from the discharge cells 54 located close to the display region 6 to the discharge cells 54 located close to the non-display region 10.

In this embodiment, the area of the discharge cells 54 in the intermediate region 8 is gradually enlarged from the location close to the display region 6 to the location close to the non-display region 10 to thereby compensate for the radical temperature variation between the display region 6 and the non-display region 10. Accordingly, a possible significant temperature difference and/or a steep temperature gradient between the display region 6 and the non-display region 10 can be prevented.

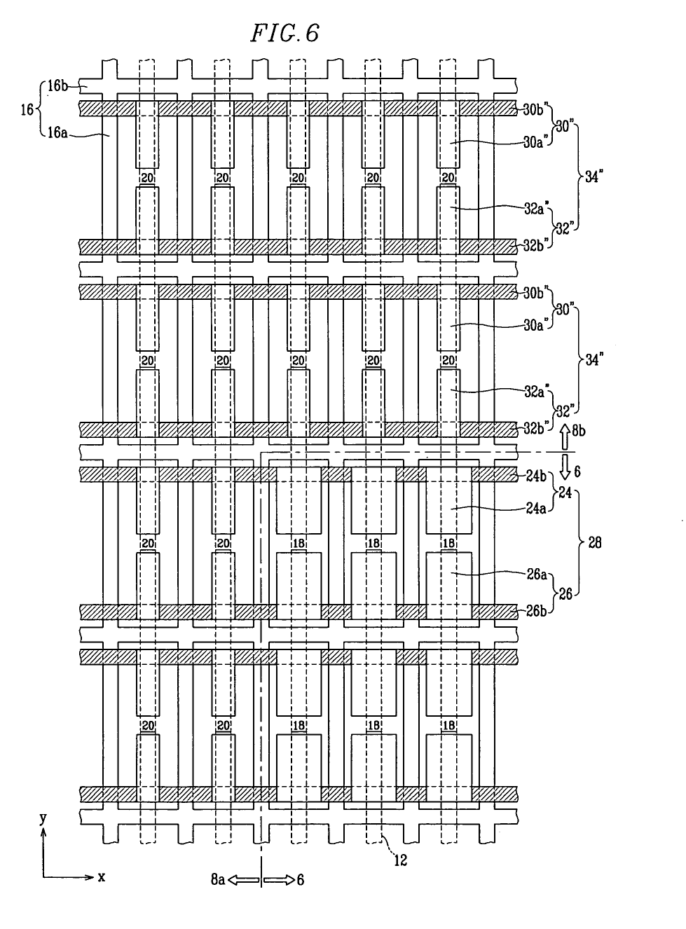

FIG. 6 is a partial plan view of a PDP according to a fourth exemplary embodiment of the present invention, illustrating a display region and an intermediate region thereof.

With the PDP, the area ratio of the display electrodes 28 and 34″ to the corresponding discharge cells 18 and 20 at the intermediate region 8 is established to be smaller than that at the display region 6. The display electrodes 34″ includes scan and sustain electrodes 30″ and 32″. Each scan electrode 30″ includes a bus electrode 30b″ and a protrusion electrode 30a″, and each sustain electrode 32″ includes a bus electrode 32b″ and a protrusion electrode 32a″. The intermediate region 8 includes a first intermediate sub-region 8a adjacent to the display region 6 in the direction parallel to the display electrodes (i.e., in the x axis direction of FIG. 6), and a second intermediate sub-region 8b adjacent to the display region 6 in the direction crossing the display electrodes.

As shown in FIG. 6, address electrodes 12 are formed at the display region 6, the first intermediate sub-region 8a, and the second intermediate sub-region 8b. The address electrodes 12 formed at the first and the second intermediate sub-regions 8a and 8b vary the flow of electric current at the first and second intermediate sub-regions 8a and 8b to thereby heighten the discharge initiation voltage of the discharge cells 20 in the intermediate sub-regions 8a and 8b. That is, in this embodiment, the address electrodes 12 are formed at the intermediate region 8 to prevent the possible mis-discharging at the intermediate region 8.

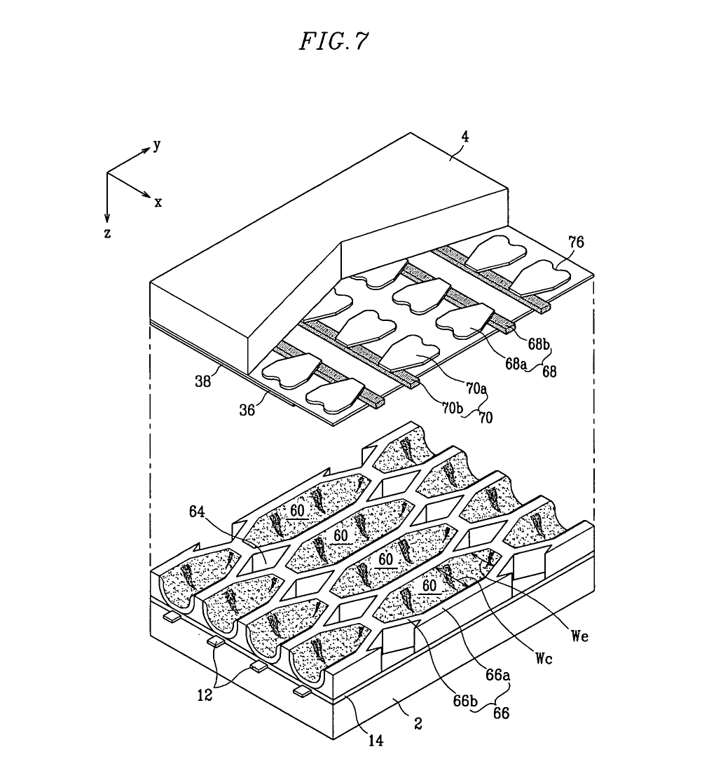

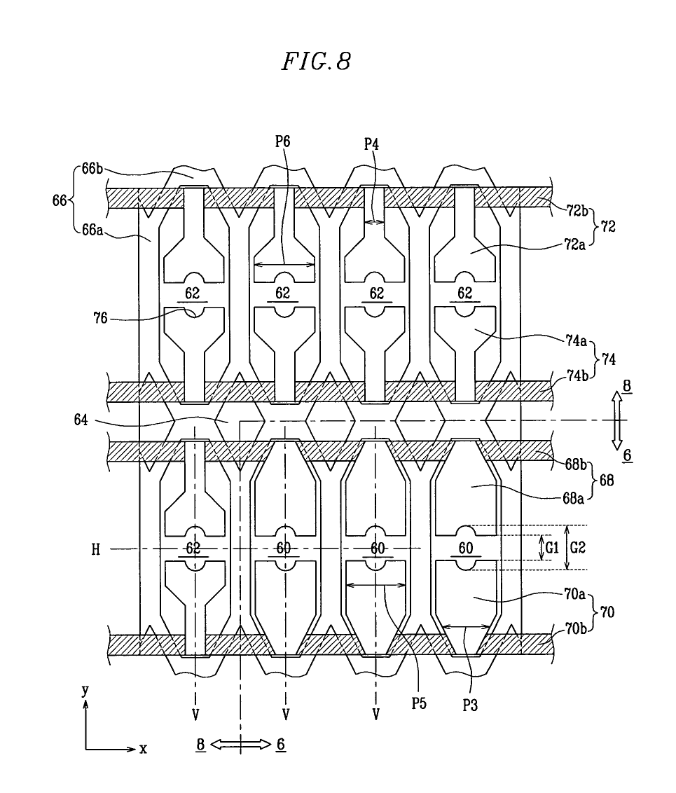

FIG. 7 is a partial exploded perspective view of a PDP according to a fifth exemplary embodiment of the present invention, illustrating discharge cells in a display region, and FIG. 8 is a partial plan view of the PDP, illustrating the discharge cells in the display region and an intermediate region.

In this embodiment, discharge cells 60 and 62 and a non-discharge region 64 are formed together between the rear substrate 2 and the front substrate 4 to thereby construct a PDP. The discharge cells 60 and 62 are used to internally make the gas discharge and the light emission, and the non-discharge region 64 refers to the region or space where the gas discharge or the light emission is not made.

As shown in FIGS. 7 and 8, the respective discharge cells 60 and 62 are formed with an optimized shape considering the diffusion pattern of the plasma discharge during the sustain discharging. The optimized structure of the discharge cells 60 and 62 is for minimizing the portions of the respective discharge cells 60 and 62 that are used to make the sustain discharging, and for enhancing the brightness. Specifically, that structure refers to the structure where the both-ended widths of the respective discharge cells 60 and 62 placed in the longitudinal direction of the address electrodes 12 (i.e., in the y axis direction of FIGS. 7 and 8) are narrowed as they go away from the respective centers of the discharge cells 60 and 62.

That is, as shown in FIG. 7, the width Wc of the discharge cells 60 and 62 at the center thereof is larger than the width We of the discharge cells at the end thereof, and the width We of the discharge cells 60 and 62 at the end thereof becomes narrower as it goes away from the center thereof. Accordingly, both ends of the discharge cells 60 and 62 are shaped as a trapezoid, and the whole plane of the respective discharge cells is shaped as an octagon.

Barrier ribs 66 are formed with first barrier rib portions 66a that extend parallel to the address electrodes 12 and second barrier rib portions 66b that cross the first barrier rib portions 66a at a predetermined angle. The second barrier rib portions 66b are disposed between the discharge cells in the direction of the address electrodes with a shape of roughly a capital letter X.

When imagined horizontal and vertical axis lines H and V are drawn over the center of the respective discharge cells 60 and 62, the non-display region 64 is placed within the area surrounded by the horizontal and vertical axis lines H and V. The non-display region 64 absorbs the heat generated from the neighboring discharge cells 60 and 62 to heighten the heat dissipation characteristic of the PDP.

In the display region 6, display electrodes 68 and 70 respectively include a bus electrode 68b and protrusion electrodes 68a, and a bus electrode 70b and protrusion electrodes 70a. In the intermediate region 8, display electrodes 72 and 74 respectively include a bus electrode 72b and protrusion electrodes 72a, and a bus electrode 74b and protrusion electrodes 74a. In this embodiment, the rear ends of the protrusion electrodes (“extension electrodes”) 68a, 70a, 72a and 74a connected to the bus electrodes 68b, 70b, 72b and 74b are narrowed in width corresponding to the shape of the discharge cells 60 and 62. Further, pairs of protrusion electrodes 68a and 70a, and 72a and 74a have grooves 76 at the center of front end edges thereof that face each other. Consequently, each pair of the protrusion electrodes 68a and 70a, and 72a and 74a has a short gap G1 therebetween at the periphery of the respective discharge cells 60 and 62, and has a long gap G2 at the center of the respective discharge cells 60 and 62.

The grooves 76 are used to induce a strong initial discharge over the wider area within the discharge cells 60 and 62 during the sustain discharging by initiating and diffusing the plasma discharge from the short gap G1 corresponding to the periphery of the discharge cells 60 and 62, and making and diffusing the plasma discharge from the long gap G2 corresponding to the center of the discharge cells 60 and 62. Accordingly, the PDP with the grooves 76 enhances the discharge efficiency, and lowers the driving voltage.

When the protrusion electrodes 68a, 70a, 72a and 74a are formed with the above shape, the area of the protrusion electrodes 72a and 74a placed within the respective discharge cells 62 at the intermediate region 8 is established to be smaller than the area of the protrusion electrodes 68a and 70a placed within the respective discharge cells 60 at the display region 6.

When the rear end width of the protrusion electrodes 68a and 70a connected to the bus electrodes 68b and 70b within the respective discharge cells 60 at the display region 6 is indicated by p3, and the rear end width of the protrusion electrodes 72a and 74a connected to the bus electrodes 72b and 74b within the respective discharge cells 62 at the intermediate region 8 by p4, the protrusion electrodes 68a, 70a, 72a and 74a are established to satisfy the condition of p3>p4.

Alternatively or additionally, the interface width (i.e., the width of the front end edges that face each other) of the pair of protrusion electrodes 68a and 70a within the respective discharge cells 60 at the display region 6 is indicated by p5 and the interface width of the pair of protrusion electrodes 72a and 74a within the respective discharge cells 62 at the intermediate region 8 by p6, the protrusion electrodes 68a, 70a, 72a and 74a are established to satisfy the condition of p5>p6.

Although certain exemplary embodiments of the present invention have been described in detail hereinabove, it should be clearly understood that many variations and/or modifications of the basic inventive concept herein taught which may appear to those skilled in the art will still fall within the spirit and scope of the present invention, as defined in the appended claims and equivalents thereof.

1. A plasma display panel comprising:
first and second substrates facing each other and having a display region at a center of the substrates, a non-display region formed around a periphery of the display region, and an intermediate region disposed between the display region and the non-display region;
address electrodes formed on the first substrate and extending parallel to each other;
barrier ribs arranged at the display region and the intermediate region, the barrier ribs defining discharge cells between the first and second substrates;
phosphor layers formed within the discharge cells in the display region; and
display electrodes formed on the second substrate in a direction crossing the address electrodes,
wherein an area ratio of the display electrodes to corresponding discharge cells in the intermediate region is smaller than an area ratio of the display electrodes to corresponding discharge cells in the display region.

2. The plasma display panel of claim 1, wherein an area of the display electrodes corresponding to respective discharge cells in the intermediate region is smaller than an area of the display electrodes corresponding to respective discharge cells in the display region.

3. The plasma display panel of claim 2, wherein the display electrodes comprise a pair of bus electrodes formed near an outer periphery of the respective discharge cells, and a pair of protrusion electrodes extending from the bus electrodes toward a center of the respective discharge cells and facing each other, and an area of the protrusion electrodes corresponding to the respective discharge cells in the intermediate region is smaller than an area of the protrusion electrodes corresponding to the respective discharge cells in the display region.

4. The plasma display panel of claim 3, wherein a width measured in a longitudinal direction of the bus electrodes of the protrusion electrodes corresponding to the respective discharge cells in the intermediate region is smaller than a width measured in the longitudinal direction of the bus electrodes of the protrusion electrodes corresponding to the respective discharge cells in the display region.

5. The plasma display panel of claim 3, wherein the discharge cells and the protrusion electrodes have a long side extending in a longitudinal direction of the address electrodes, and a short side extending in a longitudinal direction of the bus electrodes.

6. The plasma display panel of claim 3, wherein rear ends of the protrusion electrodes connected to the bus electrodes are gradually reduced in width toward the bus electrodes.

7. The plasma display panel of claim 6, wherein the rear ends of the protrusion electrodes corresponding to the respective discharge cells in the intermediate region and connected to the bus electrodes are smaller in width than the rear ends of the protrusion electrodes corresponding to the respective discharge cells in the display region.

8. The plasma display panel of claim 2, wherein a groove is formed at a center of front end edges of the pair of protrusion electrodes that face each other, and an area of the protrusion electrodes corresponding to the respective discharge cells in the intermediate region is smaller than an area of the protrusion electrodes corresponding to the respective discharge cells in the display region.

9. The plasma display panel of claim 8, wherein the width of the front end edges of the pair of protrusion electrodes corresponding to the respective discharge cells in the intermediate region is smaller than the width of the front end edges of the pair of protrusion electrodes corresponding to the respective discharge cells in the display region.

10. The plasma display panel of claim 1, wherein the area ratio of the display electrodes to the corresponding discharge cells in the intermediate region close to the non-display region is smaller than the area ratio of the display electrodes to the corresponding discharge cells in the intermediate region close to the display region.

11. The plasma display panel of claim 10, wherein the display electrodes comprise bus electrodes longitudinally extending near a periphery of respective discharge cells in a direction crossing the address electrodes, and protrusion electrodes extending from the bus electrodes toward a center of the respective discharge cells, and an area of the protrusion electrodes in the intermediate region close to the non-display region is smaller than an area of the protrusion electrodes in the intermediate region close to the display region.

12. The plasma display panel of claim 11, wherein the area of the protrusion electrodes in the intermediate region is gradually reduced from a first area of the protrusion electrodes close to the display region to a second area of the protrusion electrodes close to the non-display region.

13. The plasma display panel of claim 12, wherein a width of the protrusion electrodes measured at the intermediate region in a direction parallel to the bus electrodes is gradually reduced from a first width of the protrusion electrodes close to the display region to a second width of the protrusion electrodes close to the non-display region.

14. The plasma display panel of claim 10, wherein the discharge cells in the intermediate region have substantially the same area as each other.

15. The plasma display panel of claim 1, wherein an area of the discharge cells in the intermediate region is larger than an area of the discharge cells in the display region.

16. The plasma display panel of claim 15, wherein the area of the discharge cells in the intermediate region close to the non-display region is larger than the area of the discharge cells in the intermediate region close to the display region.

17. The plasma display panel of claim 16, wherein the area of the discharge cells in the intermediate regions is gradually enlarged from a first area of the discharge cells close to the display region to a second area of the discharge cells close to the non-display region.

18. The plasma display panel of claim 15, wherein the intermediate region comprises a first intermediate sub-region adjacent to the display region in a direction of the display electrodes, and a second intermediate sub-region adjacent to the display region in a direction crossing the display electrodes.

19. The plasma display panel of claim 18, wherein a width of the discharge cells in the first intermediate sub-region measured in the direction of the display electrodes is gradually enlarged from a first width of the discharge cells close to the display region to a second width of the discharge cells close to the non-display region.

20. The plasma display panel of claim 18, wherein a length of the discharge cells in the second intermediate sub-region measured in the direction crossing the display electrodes is gradually enlarged from a first length of the discharge cells close to the display region to a second length of the discharge cells close to the non-display region.

21. The plasma display panel of claim 15, wherein the display electrodes corresponding to the respective discharge cells in the intermediate region have substantially the same area as each other.

22. The plasma display panel of claim 1, wherein the address electrodes are formed in the display region.

23. The plasma display panel of claim 1, wherein the address electrodes are formed in the display region as well as in the intermediate region.
